(19) United States
(12) Patent Application Publication
(10) Pub. No.: US 2010/0252078 A1
(43) Pub. Date: Oct. 7, 2010

(54) Apparatus for Recycling Noble Metals

(76) Inventors: Chin-Hsiung YANG, Tao-Yuan County (TW); Hsin-Yi Tsai, Tao-Yuan County (TW)

Correspondence Address: SINORICA, LLC, 2275 Research Blvd., Suite 500, ROCKVILLE, MD, 20850, US

(21) Appl. No.: 12/487,800

(22) Filed: Jun. 19, 2009

(30) Foreign Application Priority Data
Apr. 2, 2009 (TW) 098110991

(51) Int. Cl. B01J 19/00; B01D 11/02

(52) U.S. Cl. 134/61; 422/268

(57) ABSTRACT

The present invention provides an apparatus for recycling noble metals, which comprises one or more conveyers, one or more carriers, an immersion device, one or more dissolution devices, and one or more rinse devices. The carriers, the immersion device, the dissolution devices, and the rinse devices are arranged in U-shape. Thereby, adding an object containing noble metals or pouring the object containing noble metals can be performed on the same side of the apparatus for recycling noble metals. Hence, a user needs not to operate on both sides of the apparatus for recycling noble metals, enhancing ease of operation. The carriers carry objects containing noble metals. The conveyer is used for conveying the carriers to the immersion device, the dissolution devices, and the rinse devices sequentially for recycling noble metals from the objects containing noble metals. The apparatus according to the present invention can recycle noble metals continuously. Thereby, the speed of recycling is enhanced, and the amount of recycled noble metals is increased as well.

### FIELD OF THE INVENTION

The present invention relates to a recycling apparatus, and particularly to an apparatus for recycling noble metals.

### BACKGROUND OF THE INVENTION

With advancement of technologies, the electronics industry develops prosperously. Waste derived from electronic components increases daily. The waste includes integrated circuits, printed circuit board, resistors, or capacitors, and comprising elements of copper, lead, aluminum, iron, and noble metals. If the waste is not recycled and processed appropriately, the environment will be polluted and, from the perspective of fully utilizing the noble metals, it is invisible squander.

The recycling process of waste containing metals is mainly focused on recycling and reusing valuable metals including high-priced noble metals such as gold and palladium. For example, the waste containing gold comes from the integrated circuit industry and the printed circuit board industry. In the processes of thin-film deposition or metallization in the integrated circuit industry, a lot of waste containing gold is produced including replaced molds and derived waste from vapor deposition materials, waste liquid during gold metallization, waste wafers containing gold, gold powder, waste resins containing gold, waste catalyst containing gold, and waste iodine liquid containing gold, etc.

As the electronics industry progresses towards the trend of smaller, thinner, and more efficient, the selection and development of materials is crucial. For example, in the selection of electrode materials for multilayer ceramic capacitors, palladium is usually regarded as the electrode material of choice owing to its superior conductivity and low reactivity at high temperatures. However, because palladium is costly, it is important to recycle and reuse palladium effectively during the development of multilayer materials using palladium alloys.

Currently, there is no apparatus that can recycle noble metals systematically. In most cases, recycling of noble metals is performed manually. The present invention provides an apparatus for recycling noble metals systematically. Thereby, the speed of recycling is enhanced, and the amount of recycled noble metals is increased as well.

### SUMMARY

An objective of the present invention is to provide an apparatus for recycling noble metals, which can recycle noble metals continuously. Thereby, the speed of recycling is enhanced, and the amount of recycled noble metals is increased as well.

Another objective of the present invention is to provide an apparatus for recycling noble metals, which can recycle noble metals automatically.

Still another objective of the present invention is to provide an apparatus for recycling noble metals. The devices in the apparatus for recycling noble metals are arranged in U-shape. Thereby, adding an object containing noble metals or pouring the object containing noble metals can be performed on the same side of the apparatus for recycling noble metals. Hence, a user needs not to operate on both sides of the apparatus for recycling noble metals, enhancing ease of operation.

In order to achieve the objectives described above, the present invention provides an apparatus for recycling noble metals, which comprises one or more conveyers, one or more carriers, an immersion device, one or more dissolution devices, and one or more rinse devices. The carriers, the immersion device, the dissolution devices, and the rinse devices are arranged in U-shape. The carriers are set on the conveyer, which conveys the carriers to the immersion device, the dissolution devices, or the rinse devices. The carriers carry objects containing noble metals, and are conveyed to the immersion device, the dissolution devices, and the rinse devices sequentially by the conveyer for recycling noble metals.

### BRIEF DESCRIPTION OF THE DRAWINGS

FIG. 1 shows a schematic diagram of an apparatus according to a preferred embodiment of the present invention;

FIG. 2 shows a schematic diagram of a carrier according to a preferred embodiment of the present invention;

FIG. 3 shows a schematic diagram of a carrier according to another preferred embodiment of the present invention;

FIG. 4A shows a top view of an apparatus according to another preferred embodiment of the present invention;

FIG. 4B shows a side view of an apparatus according to another preferred embodiment of the present invention;

FIG. 5 shows a schematic diagram of a carrier according to another preferred embodiment of the present invention; and

FIG. 6 shows a schematic diagram of a drain device according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

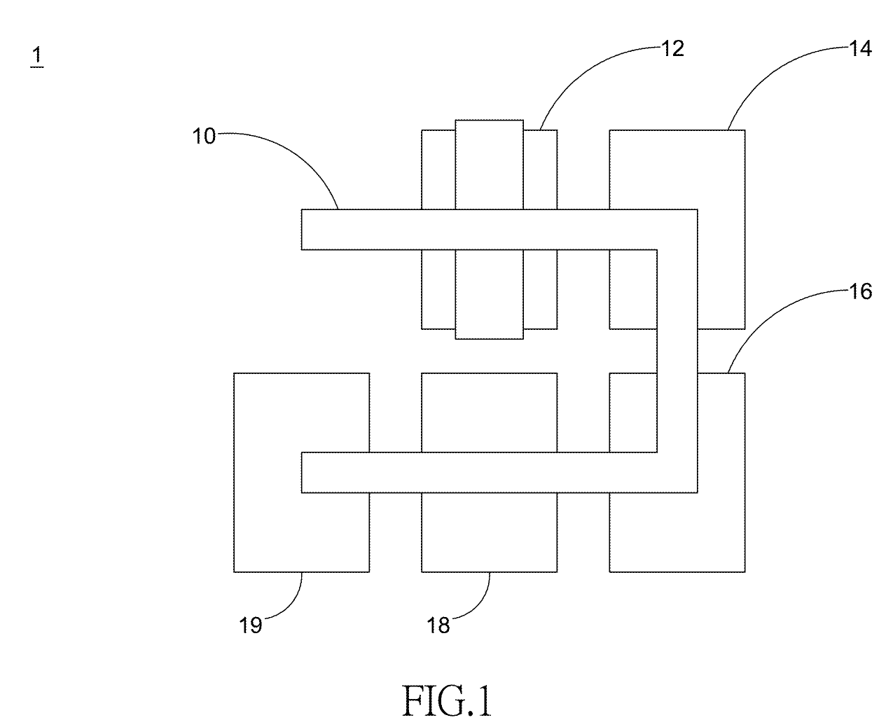

FIG. 1 shows a schematic diagram of an apparatus according to a preferred embodiment of the present invention. As shown in the figure, the present invention provides an apparatus for recycling noble metals 1, which comprises one or more conveyers 10, one or more carriers 12, an immersion device 14, one or more dissolution devices 16, and one or more rinse devices 18. The conveyer 10 is a hoist, used for conveying the carrier 12 to the immersion device 14, the dissolution devices 16, or the rinse devices 18. The carriers 12, the immersion device 14, the dissolution devices 16, and the rinse devices 18 are arranged in U-shape. The conveyer 10 is a hoist, used for conveying the carrier 12 to the immersion device 14, the dissolution devices 16, or the rinse devices 18. Thereby, adding an object containing noble metals or pouring the object containing noble metals can be performed on the same side of the apparatus for recycling noble metals. Hence, a user needs not to operate on both sides of the apparatus for recycling noble metals, enhancing ease of operation.

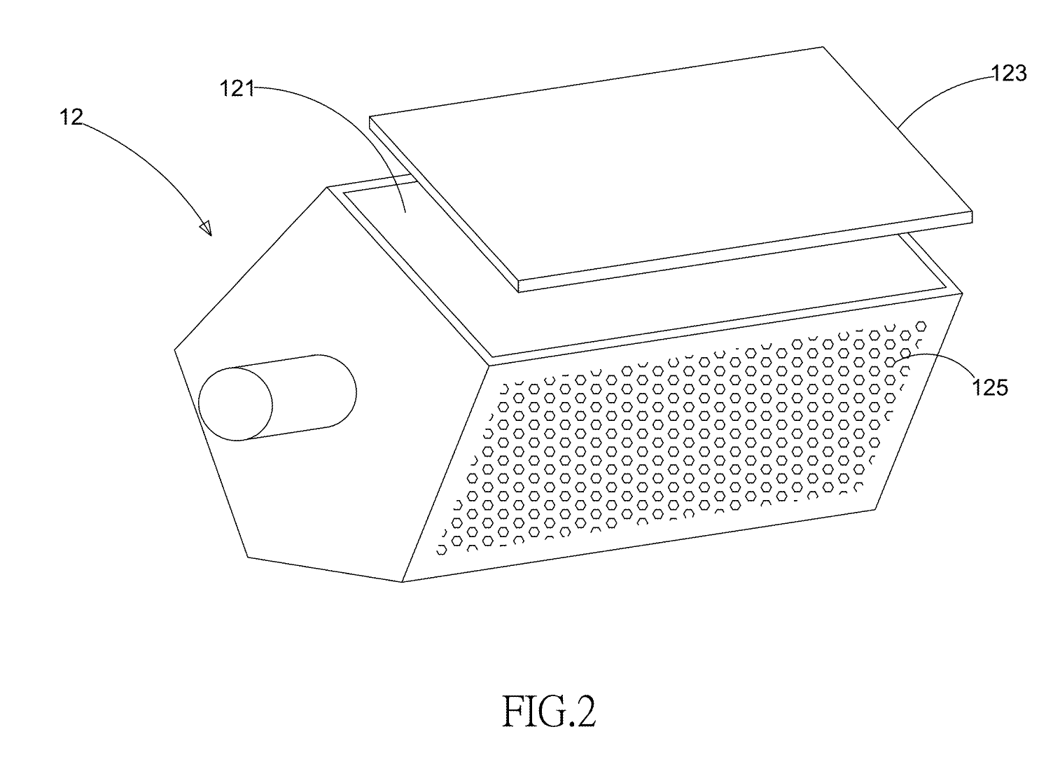

FIG. 2 shows a schematic diagram of a carrier according to a preferred embodiment of the present invention. As shown in the figure, the carrier 12 is a pentagonal prism. The carrier 12 can also be any prism. The carrier 12 carries an object containing noble metals, and comprises an opening 121 and a lid 123 on one side. The object containing noble metals is put from the opening 121. The carrier 12 has a plurality of meshes 125. The carrier 12 carrying the object containing noble metals is conveyed to the immersion device 14 by the conveyer 10. The immersion device 14 contains a solution, which is water. When the carrier 12 carrying the object containing noble metals is immersed into the solution contained by the immersion device 14, the solution enters the carrier 12 via the plurality of meshes 125 thereof, and the object containing noble metals will be soaked and spread. On the inner surface of the carrier 12, a plurality of bumps (not shown in the figure) is set. Thereby, when pouring the object remained in the carrier 12, sticking of the object in the carrier 12 can be avoided.

After the carrier 12 is immersed in the immersion device 14, pull up the carrier 12 immersed in the immersion device 14 by means of the conveyer 10. The conveyer 10 then conveys the carrier 12 to the dissolution device 16. The dissolution device 16 contains a solution, which can dissolve one or more noble metals contained in the object containing noble metals. When the carrier 12 is immersed in the solution contained in the dissolution device 16, the solution can dissolve noble metals contained in the object containing noble metals, and leave the object containing few noble metals in the carrier 12.

Next, pull up the carrier 12 immersed in the dissolution device 16 by means of the conveyer 10. The conveyer 10 then conveys the carrier 12 containing the object containing few noble metals to the rinse device 18. The rinse device 18 rinses the object containing few noble metals and residual noble metals left on the object carried by the carrier 12. Thereby, noble metals can be recycled from the solution contained in the dissolution device 16 and the rinse device 18. It is known from above description that the apparatus for recycling noble metals 1 according to the present invention has a plurality of carriers 12, and can use the conveyer 10 to perform immersion, dissolution, and rinse procedures sequentially.

Finally, the conveyer 10 conveys the object containing no noble metals to a pour device 19 for pouring the object in the carrier 12 to the pour device 19. On the inner surface of the pour device 19, a plurality of bumps (not shown in the figure) is set. Thereby, sticking of the object in the pour device 19 can be avoided.

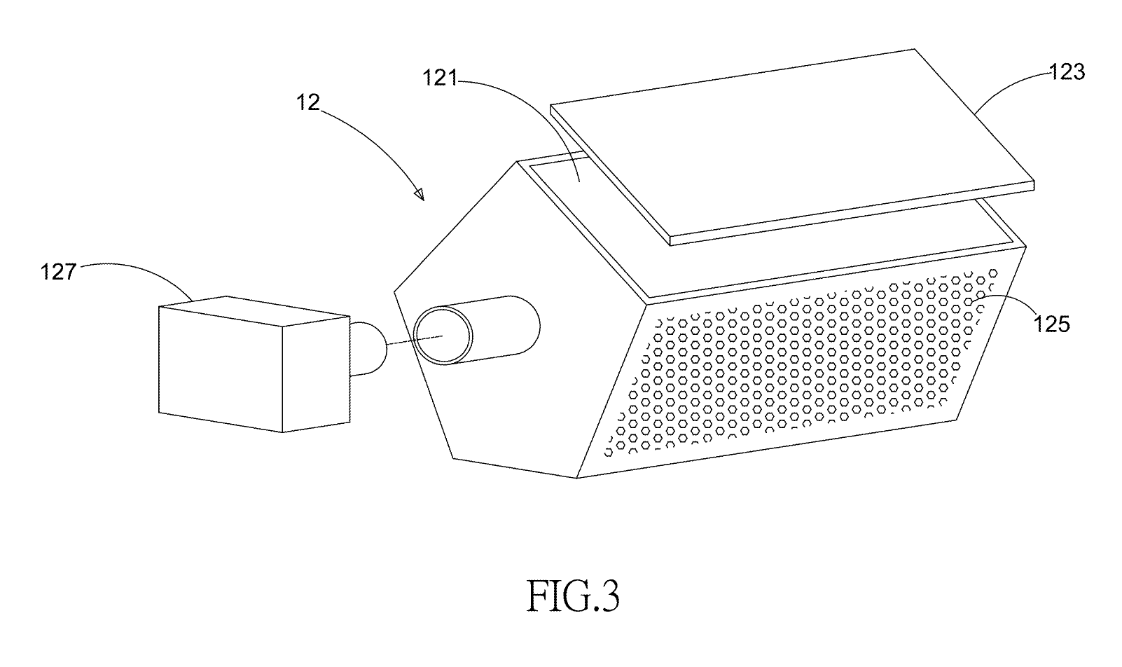

FIG. 3 shows a schematic diagram of a carrier according to another preferred embodiment of the present invention. As shown in the figure, in order to make the object containing noble metals be soaked, spread, and dissolved uniformly and to make the object containing few noble metals be rinsed uniformly, the carrier 12 further comprises a driving device 127, which can drive the carrier 12 to spin.

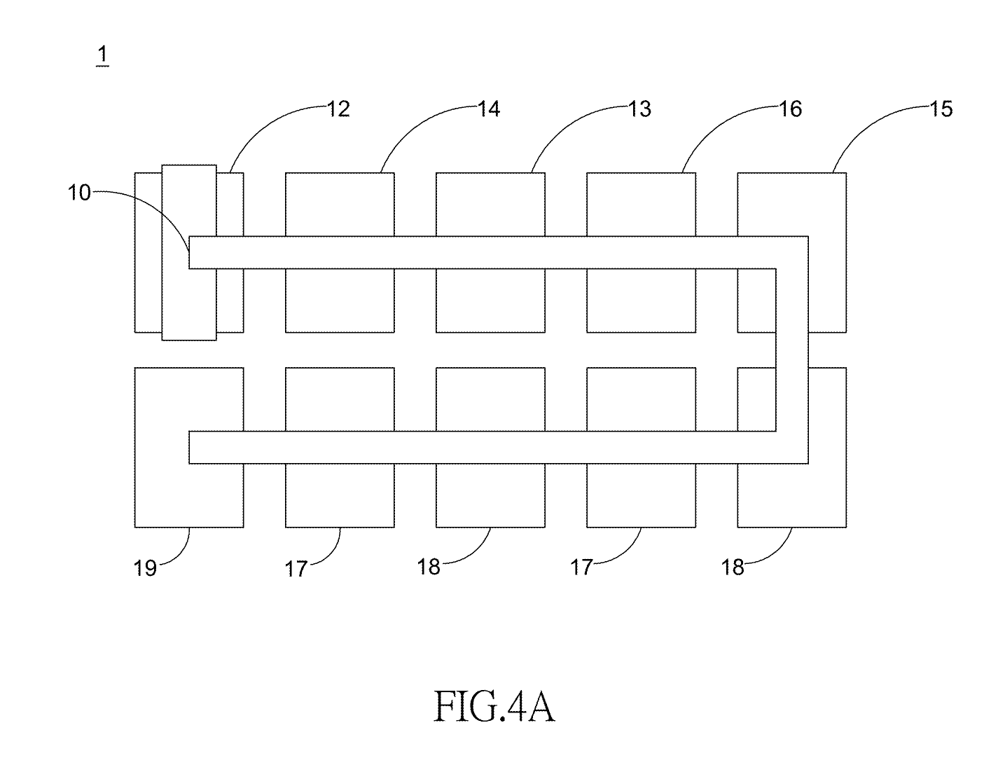

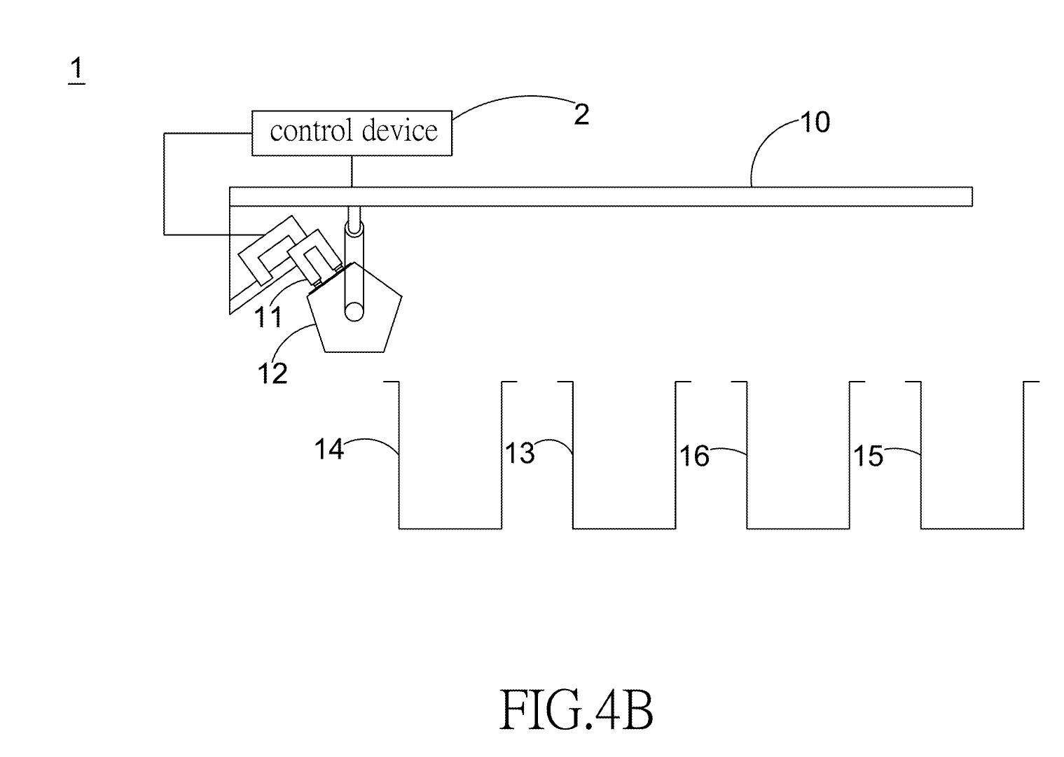

FIG. 4A and FIG. 4B show a top view and a side view of an apparatus according to another preferred embodiment of the present invention. As shown in the figure, the present preferred embodiment provides an apparatus for recycling noble metals 1 automatically. In order to make the apparatus for recycling noble metals 1 operate automatically, the apparatus for recycling noble metals 1 further comprises a manipulator 11 and a control device 2. The manipulator 11 can clip and hold the lid 123 of the carrier 12. The control device 2 is connected to the conveyer 10 and the manipulator 11, controls the conveyer 10 to convey the carrier 12, and controls the manipulator 11 to clip and hold the lid 123 of the carrier 12. The control device 2 can further control the driving device 127 according to the preferred embodiment of FIG. 3. In addition, a still device 13 is set between the immersion device 14 and the dissolution device 16. According to the present preferred embodiment, two rinse devices 18 are set. A still device 15 is set between the dissolution device 16 and the rinse device 18. A still device 17 is further set between the two rinse devices 18. Between the rinse device 18 adjacent to the pour device 19 and the pour device 19, a still device 17 is further set. The immersion device 2, the still device 13, the dissolution device 16, the still device 15, the two rinse devices 18, and the two still devices 17 are arranged sequentially in U-shape.

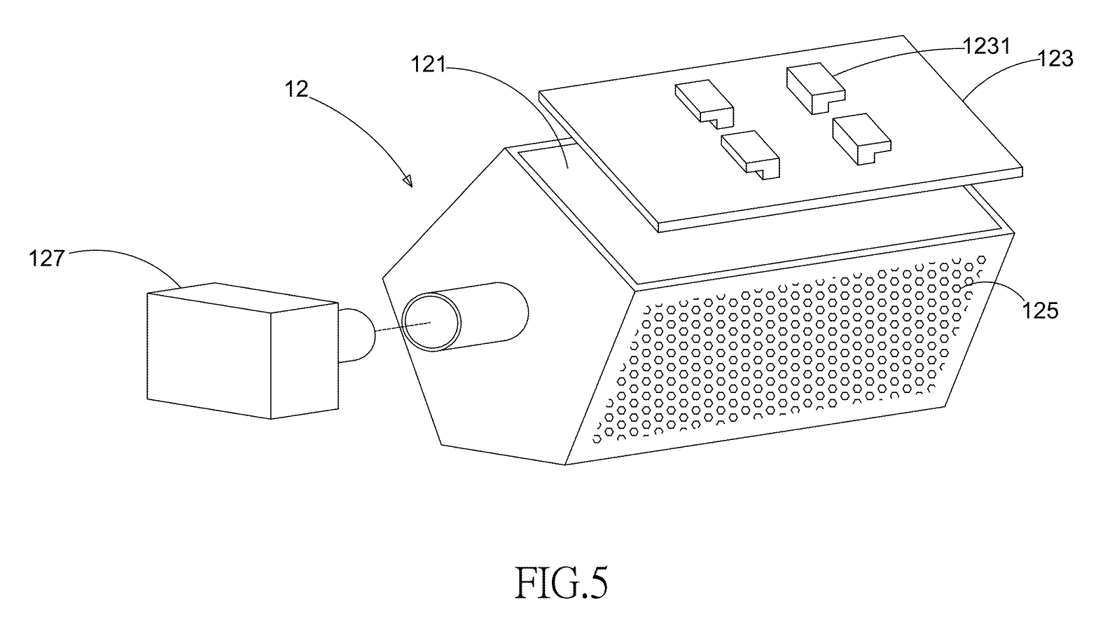

Referring to FIG. 5, the lid 123 of the carrier 12 further has a holding part 1231. The control device 2 controls the manipulator 11 to clip and hold the holding part 1231 on the lid 123 of the carrier 12 for opening and moving the lid 123. Then, the object containing noble metals can be added from the opening 121 of the carrier 12. Afterwards, the control device 2 controls the manipulator 11 to clip and hold the holding part 1231 on the lid 123 of the carrier 12, and to move the lid 123 to cover the opening 121 of the carrier 12.

The conveyer 10 conveys the carrier 12 to the immersion device 14, the dissolution device 16, or the rinse device 18. The carrier 12 carries an object containing noble metals. The carrier 12 carrying the object containing noble metals is conveyed to the immersion device 14 by the conveyer 10. The immersion device 14 contains a solution, which is water. When the carrier 12 carrying the object containing noble metals is immersed into the solution contained by the immersion device 14, the object containing noble metals will be soaked and spread.

Next, pull up the carrier 12 immersed in the immersion device 14 by means of the conveyer 10. The conveyer 10 then conveys the carrier 12 to the still device 13 and still for a while. Afterwards, the conveyer 10 conveys the carrier 12 to the dissolution device 16. The dissolution device 16 contains a solution, which can dissolve one or more noble metals contained in the object containing noble metals. When the carrier 12 is immersed in the solution contained in the dissolution device 16, the solution can dissolve noble metals contained in the object containing noble metals, and leave the object containing few noble metals in the carrier 12.

Afterwards, pull up the carrier 12 immersed in the dissolution device 16 by means of the conveyer 10. The conveyer 10 then conveys the carrier 12 to the still device 15 and still for a while. Afterwards, the conveyer 10 conveys the carrier 12 containing the object containing few noble metals to the rinse device 18. The rinse device 18 rinses the object containing few noble metals and residual noble metals left on the object carried by the carrier 12. Then, pull up the carrier 12 immersed in the rinse device 18 by means of the conveyer 10. The conveyer 10 then conveys the carrier 12 to the still device 17. Thereby, noble metals can be recycled from the solution contained in the dissolution device 16 and the rinse device 18. The apparatus for recycling noble metals 1 according to the present preferred embodiment can have a plurality of carriers 12, and can use the conveyer 10 to hoist the carriers 12 and to perform immersion, still, dissolution, still, and rinse procedures sequentially.

Finally, the conveyer 10 conveys the carrier 12 carrying the object containing no noble metals to the pour device 19. The manipulator 11 clips and holds the holding part 1231 on the lid 123 of the carrier 12 for opening and moving the lid 123. Then, the object in the carrier 12 is poured to the pour device 19. On the inner surface of the pour device 19, a plurality of bumps is set. Thereby, sticking of the object in the pour device 19 can be avoided.

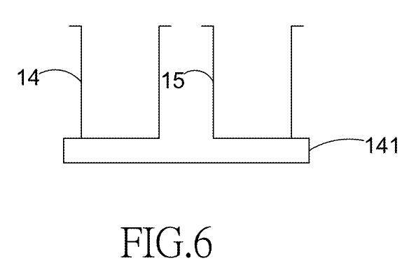

FIG. 6 shows a schematic diagram of a drain device according to another preferred embodiment of the present invention. As shown in the figure, following the preferred embodiment of FIG. 4, a drain device 141 is set below the immersion device 14 and the still device 13. When the carrier 12 is pulled up from the immersion device 14, the solution carried by the immersion device 14 is drained to the drain device 141 from the bottom of the immersion device 14. Because the still device 13 contains no solution originally, there is few solution drained from the still device 13. Thereby, most of the solution in the drain device 141 comes from the immersion device 14. The drain device 141 spans the immersion device 14 and the still device 13. Besides, The height of the drain device 141 can be lowered.

To sum up, the present invention provides an apparatus for recycling noble metals, which can recycle noble metals continuously. The apparatus for recycling noble metals is an automatic apparatus. Thereby, the speed of recycling is enhanced, and the amount of recycled noble metals is increased as well. The devices in the apparatus for recycling noble metals according to the present invention are arranged in U-shape. Thereby, adding an object containing noble metals or pouring the object containing noble metals can be performed on the same side of the apparatus for recycling noble metals. Hence, a user needs not to operate on both sides of the apparatus for recycling noble metals, enhancing ease of operation.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. An apparatus for recycling noble metals, comprising:
one or more carriers, carrying an object containing noble metals;
one or more conveyers, set on the carriers, and conveying the carriers;
an immersion device, containing a solution, the conveyer conveying the carrier carrying the object containing noble metals to the immersion device, and the carriers immersing in the immersion device;
one or more dissolution device, containing a solution, the carrier immersing in the dissolution device for dissolving, and the solution dissolving the noble metals contained in the object containing noble metals; and
one or more rinse devices, rinsing the carrier, and washing the noble metals out of the object containing noble metals for recycling the noble metals from the dissolution device and the rinse device;
wherein the carriers, the immersion devices, the dissolution devices, and the rinse devices are arranged in U-shape.

2. The apparatus for recycling noble metals of claim 1, wherein on one side of the carrier, an opening and a lid are set, and the lid is set on the opening.

3. The apparatus for recycling noble metals of claim 1, wherein the carrier is a pentagonal prism.

4. The apparatus for recycling noble metals of claim 2, and further comprising a manipulator, clipping and holding the lid of the carrier for opening and moving the lid.

5. The apparatus for recycling noble metals of claim 1, wherein on the inner surface of the carrier, a plurality of bumps is set.

6. The apparatus for recycling noble metals of claim 4, wherein the lid of the carrier has a holding part, and the manipulator clips and holds the holding part for opening and moving the lid.

7. The apparatus for recycling noble metals of claim 1, and further comprising a pour device, carrying the object containing noble metals in the carrier after rinse.

8. The apparatus for recycling noble metals of claim 7, wherein on the inner surface of the pour device, a plurality of bumps is set.

9. The apparatus for recycling noble metals of claim 1, wherein the converyer is a hoist.

10. The apparatus for recycling noble metals of claim 1, and further comprising a control device, connecting to and controlling the conveyer and the manipulator.

11. The apparatus for recycling noble metals of claim 1, wherein the carrier further comprises a driving device, driving the carrier to spin.

12. The apparatus for recycling noble metals of claim 11, and further comprising a control device, connecting to and controlling the conveyer, the driving device, and the manipulator.

13. The apparatus for recycling noble metals of claim 1, wherein the carrier has a plurality of meshes.

14. The apparatus for recycling noble metals of claim 1, wherein the solution contained in the immersion device is water.

15. The apparatus for recycling noble metals of claim 1, wherein the solution contained in the dissolution device can dissolve the noble metals.

16. The apparatus for recycling noble metals of claim 1, wherein a still device is further set between the immersion device and the dissolution device.

17. The apparatus for recycling noble metals of claim 16, and further comprising a drain device, set below the immersion device and the still device.

18. The apparatus for recycling noble metals of claim 1, wherein a still device is further set between the dissolution device and the rinse device.

19. The apparatus for recycling noble metals of claim 7, wherein a still device is further set between the rinse device and the pour device.
